(19) United States
(12) Patent Application Publication
(10) Pub. No.: US 2012/0198978 A1
(43) Pub. Date: Aug. 9, 2012

(54) SHEARING SYSTEM FOR MOVING PRODUCT

(75) Inventor: William X. Shen, Boylston, MA (US)

(73) Assignee: SIEMENS INDUSTRY, INC., Alpharetta, GA (US)

(21) Appl. No.: 13/022,167

(22) Filed: Feb. 7, 2011

(51) Int. Cl. B26D 7/06

(52) U.S. Cl. 83/78

(57) ABSTRACT

A shearing system is adapted to remove a portion of product having a main product length moving along a line. The system comprises: a pair of parallel shafts arranged approximately normal to the line; a hub assembly carried by the pair of a parallel shafts and comprising a pair of first cutting blades in a first cutting zone adjacent to one side of the line; a drive assembly for continuously rotating the shafts in opposing directions; and a switching assembly for deflecting the product from the line along a path bypassing the first cutting zone and for sequentially traversing the product. The hub assembly can further comprise a pair of second cutting blades in a second cutting zone separated by the first cutting zone by a neutral zone without cutting blades. Also, the hub assembly can comprise multiple pairs of third cutting blades in a third cutting zone bordering the second cutting zone.

### BACKGROUND

1. Field

Embodiments of the present invention relate to a shearing system for cutting a portion of a moving product and, more particularly, to rotary shears employed in rolling mills to remove the front and tail ends of hot rolled. rods and bars as they move longitudinally along the mill pass line.

2. Description of Related Art

Conventional rotary shears employ switches to laterally traverse the hot rolled products across shear cutting zones. Because of the arrangement and number of the shear blades in the cutting zones, the switches must traverse the products at a rapid rate, which in turn can cause the products to bend and cobble.

### SUMMARY

Briefly described, embodiments of the present invention relate to a shearing system adapted to remove a portion of an item.

Aspects of the present invention address problems in the prior art by generating critical front and tail end cuts with a shearing system. In an exemplary embodiment, the shearing system includes a single pair of shear blades located in cutting zones separated by a neutral zone devoid of shear blades. In this arrangement, the product to be cut can be traversed across the cutting zones at a slower rate, thereby reducing abrupt bending and potential cobbling of hot rolled products.

In an exemplary embodiment, a shearing system, which can be rotary in design, can remove a front end, as well as a tail end of an item. The item can be a hot rolled product that is moving lengthwise along a mill pass line,

The shearing system comprises a pair of parallel shafts arranged orthogonally with respect to the pass line. Hubs carried by the shafts can be configured with a pair of first cutting blades in a first cutting zone adjacent to the pass line, with a pair of second cutting blades in a second cutting zone spaced from the first cutting zone by a neutral zone aligned with the pass line and devoid of cutting blades, and with multiple pairs of third cutting blades in a third cutting zone bordering the second cutting zone. The shafts can continuously rotate in opposite directions, and a switching assembly can initially deflect the product front end from the pass line along a path bypassing the shear cutting zones and to then traverse the product from the bypass path across the first cutting zone into the neutral zone. As the product traverses the first cutting zone, the first cutting blades coact to sever the product front end from the main product length. The main product length remains intact as it continues to pass through the neutral zone along the pass line, As the product tail end approaches the shear, the switching assembly traverses the product across the second and third cutting zones. The second cutting blades coact to sever the product tail end from the main product length, and the product tail end is subdivided into shorter crop lengths by the third cutting blades in the third cutting zone.

Because only single pairs of cutting blades are provided in the first and second cutting zones, the product can be traversed across those zones during rotation of the cutting blades through 360° minus the bite angle of the blades. This allows for a slower rate of traverse which beneficially averts product bending and cobbling.

These and other embodiments, objects, features, and advantages of the present invention will become more apparent upon reading the following specification in conjunction with the accompanying drawing figures.

### BRIEF DESCRIPTION OF THE DRAWINGS

FIG. 1 is a side view of a shear assembly, in accordance with an exemplary embodiment of the present invention.

FIG. 2 is a plan view of the shearing system, in accordance with an exemplary embodiment of the present invention.

FIG. 3 is a sectional view of the shearing system taken along line 3-3 of FIG. 2, in accordance with an exemplary embodiment of the present invention.

FIG. 4 is a sectional view of a receiving trough of the shearing system taken along line 4-4 of FIG. 2, in accordance with an exemplary embodiment of the present invention.

FIG. 5 is a perspective view of a hubs and shear blades of the shearing system, in accordance with an exemplary embodiment of the present invention.

FIG. 6 is a schematic illustration of the shear blades and shear zones through which a product can traverse, in accordance with an exemplary embodiment of the present invention.

FIGS. 7A-7D are schematic illustrations depicting progress of the product through the shear zones, in accordance with an exemplary embodiment of the present invention.

FIGS. 8A-8D are schematically illustrations depicting a role of a receiving trough, in accordance with an exemplary embodiment of the present invention.

### DETAILED DESCRIPTION

To facilitate an understanding of embodiments, principles, and features of the present invention, they are explained hereinafter with reference to implementation in illustrative embodiments. In particular, they are described in the context of being a shearing system.

Embodiments of the present invention, however, are not limited to use in the described shearing system. Rather, embodiments of the present invention can be used when a cutting system is desired or necessary. Thus, the shearing system described hereinafter as an assembly for use in rolling mills to remove front and tail ends of a rolled product can also find utility as a system or assembly for other applications.

The components and materials described hereinafter as making up the various embodiments are intended to be illustrative and not restrictive. Many suitable components and materials that would perform the same or a similar function as the materials described herein are intended to be embraced within the scope of embodiments of the present invention.

Referring now to the figures, wherein like reference numerals represent like parts throughout the views, embodiments of the present invention will be described in detail.

In an exemplary embodiment, a shearing system is configured to remove a front end and/or a tail end of a moving product. For example, the shearing system is adapted to remove the front and tails ends of a hot rolled product moving along a mill pass line.

The shearing system comprises a pair of parallel shafts, at least one hub assembly, a drive assembly, and a switching assembly.

The pair of parallel shafts is arranged orthogonally relative to the mill pass line.

The hub assembly can be carried by the pair of parallel shafts. In addition, the hubs are configured with a first pair of cutting blades in a first cutting zone that is adjacent to one side of the mill pass line. A second pair of cutting blades is arranged in a second cutting zone that is separated from the first cutting zone by a neutral zone. The neutral zone is devoid of cutting blades and is aligned with the mill pass line. A third cutting zone can include a plurality of pairs of third cutting blades. The third cutting zone borders the second cutting zone.

The drive assembly is configured to continuously rotate the pair of parallel shafts in opposing directions.

The switching assembly can deflect the moving product from the mill pass line along a path that bypasses the first cutting zone and for sequentially traversing the moving product: from the path across the first cutting zone into the neutral zone, resulting in the first cutting blades coacting to sever the moving product's front end from the main product length, while allowing the main product length to continue moving through the neutral zone along the mill pass line; from the neutral zone across the second cutting zone, resulting in the second cutting blades coacting to sever the moving product's tail end from the main product length; and from the second cutting zone across the third cutting zone, resulting in the third cutting blades subdividing the now severed product tail end into shorter crop lengths.

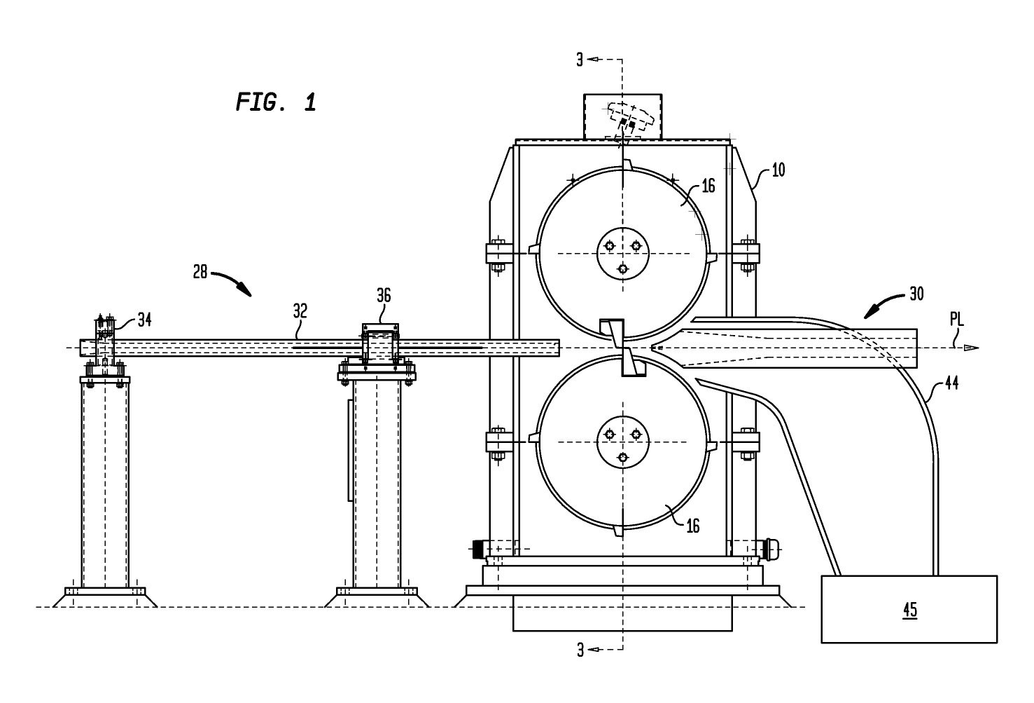

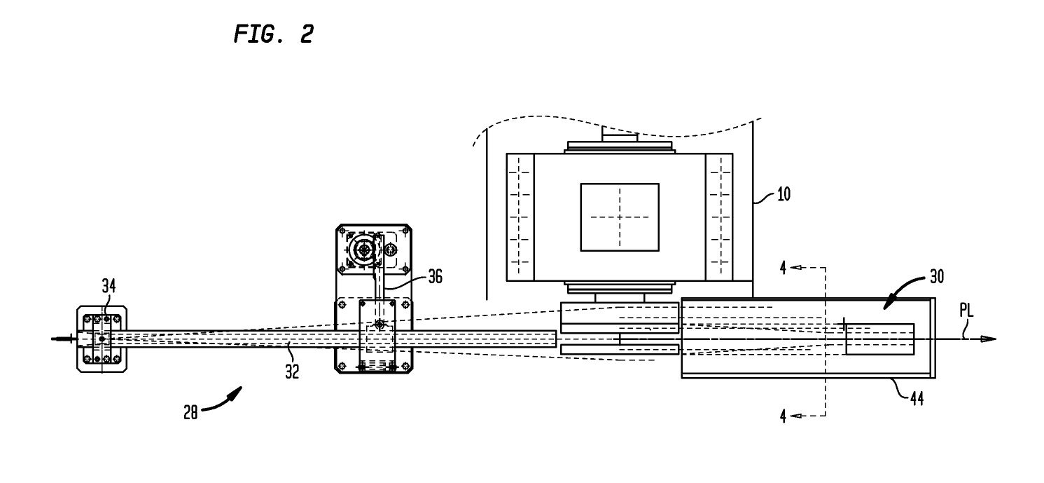

With reference initially to FIGS. 1-3, a shearing system in accordance with the present invention is illustrated. The shearing system comprises a housing 10 that contain a pair of parallel shafts 12. The pair of parallel shafts 12 is journaled for rotation between bearings 14 and are arranged approximately orthogonal relative to the mill pass line “PL” along which the hot rolled product can move longitudinally through the mill.

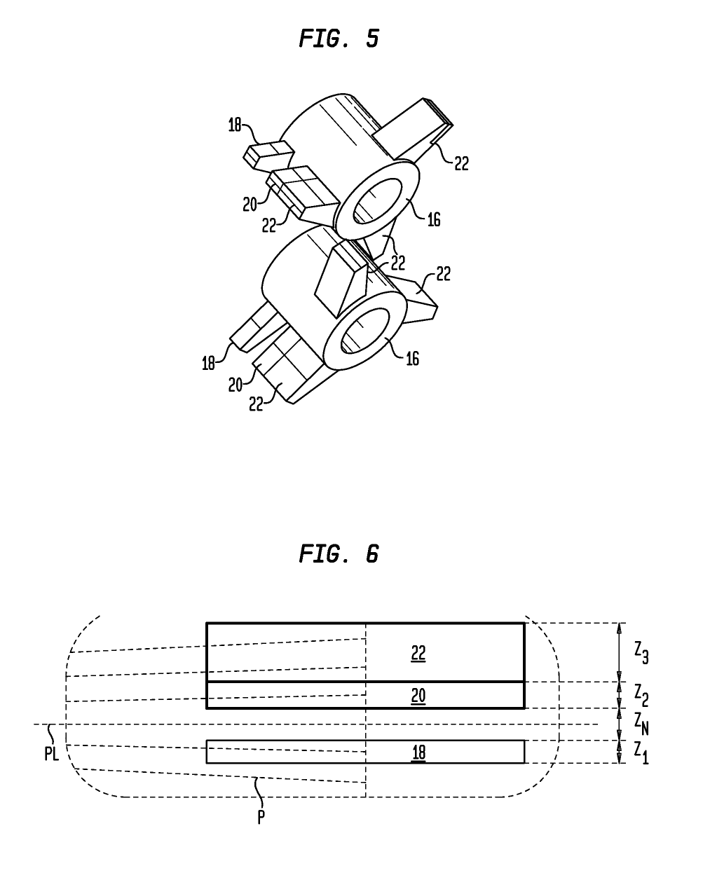

Hubs 16 can be carried by the pair of parallel shafts 12. As illustrated in FIGS. 5 and 6, the hubs 16 include a pair of first cutting blades 18 located in a first cutting zone Z₁ adjacent to mill pass line PL; a pair of second cutting blades 20 located in a second cutting zone Z₂ separated from the first zone Z₁ by a neutral zone Z_{N}; and multiple pairs of third cutting blades 22 located in a third zone Z₃ bordering the second zone Z₂,

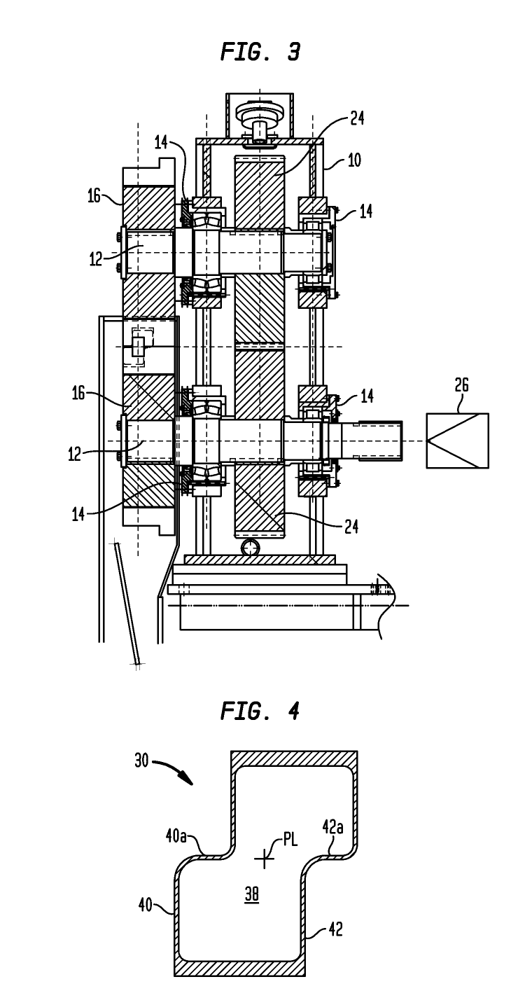

The shafts 12 are mechanically interconnected by gears 24 and can continuously rotated in opposite directions by a motor 26, which is generally illustrated in FIG. 3.

A switching assembly 28 can be arranged upstream of the shear housing 10, and a receiving trough 30 is located downstream of the shear housing 10. The switching assembly 28 comprises a guide pipe 32 that can be supported at pivot 34 and pivotally manipulated by a linear actuator 36.

As can be best seen in FIG. 4, the receiving trough 30 has a through passage 38 and first and second side walls 40, 42 with respective first and second ledges 40a, 42a. The ledge 40a projects outwardly from passage 38, whereas ledge 42a projects inwardly into the passage. The ledge 40a can be aligned with the first cutting zone Z₁, passage 38 can be aligned with the mill pass line PL and the neutral zone Z_{N}, and ledge 42a can be aligned with the second cutting zone Z₂.

The switching assembly 28 can initially direct the a guide pipe 32 from the mill pass line PL along a path P, bypassing the shear cutting zones, and then to sequentially traverse the product from path P across cutting zone Z₁ into the neutral zone Z_{N}, and from the neutral zone across cutting zones Z₂ and Z₃.

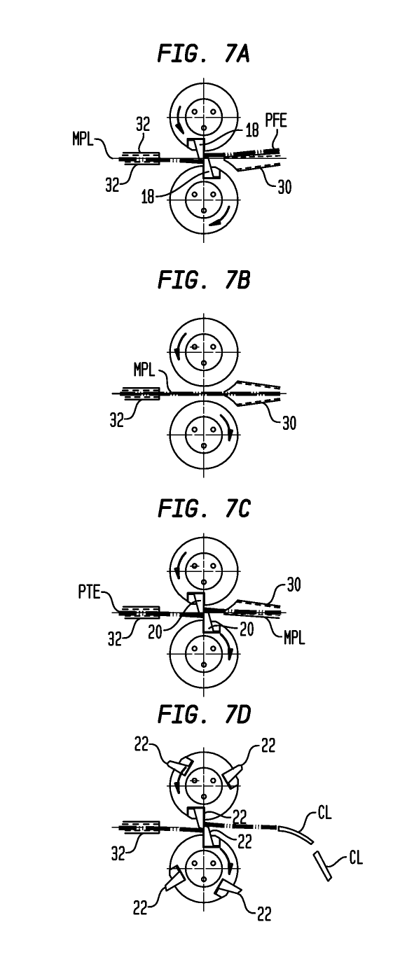

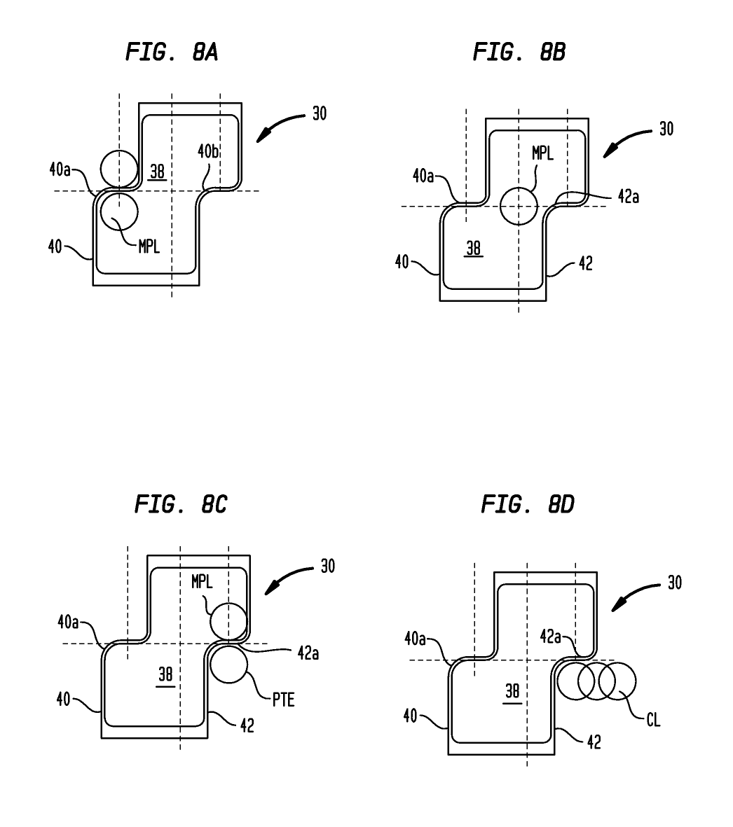

With reference to FIGS. 7A and 8A, as a product traverses cutting zone Z₁, and the first cutting blades 18 operate to sever the product front end PFE from the main product length MPL. The leading cut end of the main length MPL is deflected downwardly beneath ledge 40a, directing the main product length into passage 38 for continued movement to downstream equipment. The trailing cut end of the product front end PFE is deflected upwardly above ledge 40a, allowing the product front end to be captured by the exterior guard 44 and directed to an underlying scrap bin.

As shown in FIGS. 7B and 8B, as the main product length MPL continues to pass through the neutral zone Z_{N} and the trough passage 38, it remains intact because the neutral zone is devoid of cutting blades.

Next, as shown in FIGS. 7C and 8C, the product traverses zone Z₂, the second cutting blades 20 can sever the product tail end PTE from the main product length MPL. The leading cut end of the product tail end PTE is deflected downwardly beneath ledge 42a, and the trailing cut end of the main product length MPL is deflected upwardly above ledge 42a for continued movement trough passage 38.

Finally, as shown in FIGS. 7D and 8D, as the product continues to traverse across zone Z₃, the severed product tail end PTE is subdivided by the third cutting blades 22 into shorter crop lengths CL.

While the invention has been disclosed in exemplary forms, it will be apparent to those skilled in the art that many modifications, additions, and deletions can be made therein without departing from the spirit and scope of the invention and its equivalents, as set forth in the following claims.

What is claimed is:

1. A rotary shear for removing the front and tail ends of a hot rolled product moving along a mill pass line, said shear comprising:
a pair of parallel shafts arranged orthogonally with respect to said pass line;
hubs carried by said shafts, said hubs being configured with and a pair of first cutting blades in a first cutting zone adjacent to one side of said pass line; a pair of second cutting blades in a second cutting zone separated from said first cutting zone by a neutral zone devoid of cutting blades and aligned with said pass line; and multiple pairs of third cutting blades in a third cutting zone bordering said second zone;
drive means for continuously rotating said shafts in opposite directions; and
a switch for deflecting said product from said pass line along a path bypassing said first cutting zone and for sequentially traversing said product: from said path across said first cutting zone into said neutral zone, resulting in said first cutting blades coacting to sever the product front end from the main product length while allowing the main product length to continue moving through said neutral zone along said pass line; from said neutral zone across said second cutting zone, resulting in said second cutting blades coacting to sever the product tail end from the main product length; and from said second cutting zone across said third cutting zone, resulting in said third cutting blades subdividing the severed product tail end into shorter crop lengths.

2. The rotary shear of claim 1, wherein said switch is operative to traverse said product from said path across said first cutting zone into said neutral zone during rotation of said first cutting blades through 360° minus the blade bite angle.

3. The rotary shear of claim 1, wherein said switch is operative to traverse said product from said neutral zone across said second cutting zone during rotation of said second cutting blades through 360° minus the blade bite angle.

4. The rotary shear of claim 2, wherein said switch is operative to traverse said product from said neutral zone across said second cutting zone during rotation of said second cutting blades through 360° minus the blade bite angle.

5. The rotary shear of claim 1, wherein in the course of severing said product, the pairs of first and second cutting blades deflect a leading cut end downwardly while deflecting a trailing cut end upwardly.

6. The rotary shear of claim 5, further comprising a receiving trough located downstream from said cutting and neutral zones, said trough having a through passage aligned with said neutral zone and said pass line, and having first and second side walls, said first side wall having a first ledge aligned with said first cutting zone and projecting outwardly from said through passage, and said second side wall having a second ledge aligned with said second cutting zone and projecting inwardly into said through passage, whereupon as said product is severed by said first cutting blades, the leading cut end of the main product length is deflected downwardly beneath said first ledge and into said passage while the trailing cut end of the product front end passes above said first ledge and outside said passage, and as said product is severed by said second cutting blades, the trailing cut end of the main product length is deflected upwardly above said second ledge for continued movement through said passage while the leading cut end of the tail end passes beneath the second ledge and outside said passage.

7. The rotary shear of claim 6, wherein said receiving trough is enclosed by a guard configured and arranged to receive the severed product front end and the shorter crop lengths of the severed product tail end.

8. A shearing system adapted to remove a portion of product having a main product length moving along a line, the system comprising:
a pair of parallel shafts arranged approximately normal to the line;
a hub assembly carried by the pair of a parallel shafts, the hub assembly comprising a pair of first cutting blades in a first cutting zone adjacent to one side of the line;
a drive assembly for continuously rotating the shafts in opposing directions; and
a switching assembly for deflecting the product from the line along a path bypassing the first cutting zone and for sequentially traversing the product.

9. The shearing system of claim 8, the hub assembly further comprising a pair of second cutting blades in a second cutting zone separated by the first cutting zone by a neutral zone devoid of cutting blades.

10. The shearing system of claim 9, the hub assembly further comprising multiple pairs of third cutting blades in a third cutting zone bordering the second cutting zone.

11. The shearing system of claim 10, the switching assembly adapted to sequentially traverse the product:
from the path across the first cutting zone in to the neutral zone, resulting in the first cutting blades coact to sever a front end of the product from the main product length while allowing the main product length to continue moving through the neutral zone along the line;
from the neutral zone across the second cutting zone, resulting in the second cutting blades coacting to sever a tail end of the product from the main product length forming a severed product; and
from the second cutting zone across the third cutting zone, resulting in the third cutting blades subdividing a tail end of the severed product into shorted crop lengths.
